(19) United States
(12) Patent Application Publication
(10) Pub. No.: US 2026/0280378 A1
(43) Pub. Date: Sep. 17, 2026

(54) ELECTRIC MOTOR HAVING A STATOR HOUSING

(71) Applicant: SEW-EURODRIVE GMBH & CO. KG, Bruchsal (DE)

(72) Inventor: Li JINCHANG, Tianjin (CN)

(73) Assignee: SEW-EURODRIVE GMBH & CO. KG, Bruchsal (DE)

(21) Appl. No.: 19/163,110

(22) PCT Filed: Feb. 14, 2024
(86) PCT No.: PCT/EP2024/053771

§ 371 Date: Sep. 8, 2025

(30) Foreign Application Priority Data
Mar. 8, 2023 (CN) 202310219613.3
May 8, 2023 (DE) 10 2023 001 856.2

(51) Int. Cl. H02K 5/22; H02K 5/18; H02K 9/06

(52) U.S. Cl. CPC H02K 5/22; H02K 5/18; H02K 9/06

(57) ABSTRACT

An electric motor includes a stator housing, and the stator housing has cooling fins. A holding plate is fastened to a first cooling fin of the stator housing and to a second cooling fin of the stator housing, the first cooling fin is mutually spaced from the second cooling fin, and an oil reservoir is fastened to the holding plate.

### FIELD OF THE INVENTION

The present invention relates to an electric motor having a stator housing.

### BACKGROUND INFORMATION

In certain conventional systems, an electric motor has a stator housing.

An electric motor is described in U.S. Pat. No. 10,826,347.

An electric motor unit is described in Chinese Patent Document No. 111874094.

A drive is described in German Patent Document No. 10 2013 000 849.

An electric motor having a fan is described in Japanese Patent Document No. 2009-278807.

A geared motor is described in German Patent Document No. 10 2021 002 635.

### SUMMARY

Example embodiments of the present invention provide for making an electric motor more compact, i.e., to achieve a high power per unit volume.

According to example embodiments, in an electric motor having a stator housing, the stator housing has cooling ribs. A holding plate is fastened to a first cooling fin of the stator housing and to a second cooling fin of the stator housing, the first cooling fin is mutually spaced from the second cooling fin, and an oil reservoir is fastened to the holding plate.

An advantage of this arrangement is that the holding plate is fastened to the stator housing as an additional ground, which is configured as a bridge between the two cooling fins. Thus, the power dissipation of the electric motor is not only dissipated to the ambient air via the cooling fins of the stator housing, but also via the holding plate.

The oil reservoir makes it possible to compensate for the thermally induced change in volume of the oil of the transmission.

The oil reservoir fastened to the holding plate allows the heat dissipation of the oil reservoir—both in the cooling air flow and through contact with the holding plate. The oil reservoir is, for example, made of metal and thus connected to the holding plate in a thermally conductive manner.

The oil of the oil reservoir cooled in this manner can be made available to the transmission, which can thus transmit a higher power in the same installation space. Overall, the entire electric motor thus achieves a high power per unit volume. The electric motor is thus further provided in a compact manner.

According to example embodiments, the holding plate is arranged between the oil reservoir and the stator housing. An advantage is that the holding plate is arranged as an enlargement of the surfaces to be cooled.

According to example embodiments, a first tab region of the holding plate is connected to the first cooling fin, e.g., via screws, and a further first tab region is connected to the second cooling fin, e.g., via screws. An advantage is that the holding plate is mechanically and thermally coupled to the stator housing. Thus, improved heat dissipation to the environment is provided.

According to example embodiments, the respective first tab region has at least one continuous recess directed in the circumferential direction or directed tangentially. An advantage is that an improved fastening method can be used for the holding plate. Although making recesses in cooling fins might normally be avoided, the addition of the holding plate increases the total surface area for heat dissipation. Thus, the disadvantage caused by the recesses is more than compensated for.

According to example embodiments, the first cooling fin has at least one continuous recess directed in the circumferential direction or directed tangentially. An advantage is that an improved fastening method can be used for the holding plate. Although making recesses in cooling fins might normally be avoided, the addition of the holding plate increases the total surface area for heat dissipation. Thus, the disadvantage caused by the recesses is more than compensated for.

According to example embodiments, the second cooling fin has at least one continuous recess directed in the circumferential direction or directed tangentially. For example, a first screw projects through the first tab region and the first cooling fin and a second screw projects through the further first tab region and the second cooling fin. An advantage is that an improved fastening method can be used for the holding plate. Although making recesses in cooling fins might normally be avoided, the addition of the holding plate increases the total surface area for heat dissipation. Thus, the disadvantage caused by the recesses is more than compensated for.

According to example embodiments, the holding plate is made as a punched and bent part from metal sheet, and the respective first tab region adjoins a, e.g., flat base region of the holding part and is formed at an angle relative to the base region. An advantage of this is that the holding plate is readily and inexpensively produced.

According to example embodiments, a second tab region of the holding part adjoins the, e.g., flat base region of the holding part and is formed at an angle relative to the base region. For example, the second tab region is bent away from the stator housing starting from the base region. An advantage of this is that the second tab region faces away from the stator housing, whereas the first tab regions face toward the stator housing.

According to example embodiments, the respective first and/or second tab region is substantially flat. For example, the first tab regions are respectively bent away from the base region toward the stator housing. An advantage of this is that ready production is possible and surface contact with the respective cooling fins can be achieved.

According to example embodiments, the oil reservoir has a connection region for a vent valve and a connection region for an adapter. An advantage is that the two connection regions are spaced apart from each other so that gear oil can flow into or out of the oil reservoir via the connection region of the adapter and pressure equalization with the ambient air can be carried out via the connection region of the vent valve. For example, the connection region for the vent valve is arranged above the connection region for the adapter in the direction of gravity.

According to example embodiments, the axial direction is, for example, oriented parallel to the vertical direction. An advantage is that the axial direction is oriented parallel to the direction of gravity. The rotor shaft of the electric motor is thus, for example, oriented vertically.

According to example embodiments, the connection region for the vent valve is arranged above the connection region for the adapter. An advantage is that air accumulates above the oil of the oil reservoir, e.g., because partly oil and partly air is arranged in the oil reservoir.

According to example embodiments, a fan is connected for conjoint rotation to the rotor shaft of the electric motor, and the air flow conveyed by the fan exits between a fan hood of the electric motor and the stator housing and flows at least partially along the holding plate and/or the oil reservoir. An advantage is that the rotor shaft of the electric motor has a non-vanishing speed during operation, which is higher than the speed of any other shaft of the transmission when the transmission is arranged as a reduction transmission. Thus, a high fan delivery rate can be achieved.

According to example embodiments, the air flow conveyed by the fan is directed downwards in the direction of gravity. An advantage is that the stator housing is arranged above the transmission. The holding plate and oil reservoir are thus arranged above the transmission. When the rotor shaft is idle, a convective flow thus builds up, which flows upwards along the holding plate and the cooling fins.

According to example embodiments, the connection region for the vent valve projects through a recess of the second tab region, and, for example, a nut is screwed onto the connection region for fastening the oil reservoir to the second tab region. An advantage is that the oil reservoir is pressed against the second tab region, thus transferring the heat to the holding plate.

According to example embodiments, the rotor shaft of the electric motor drives a transmission whose inner spatial region of the transmission is filled with oil, and an oil line, e.g., a pipeline or hose line, leads from the transmission to the adapter, which is connected to the connection region for the adapter. An advantage is that thermally induced changes in the volume of the oil can be compensated by the oil reservoir. This is because the oil line allows the oil in the inner spatial region of the transmission to flow into the oil reservoir in the event of extension.

According to example embodiments, the vent valve is connected to the connection region for the vent valve. For example, the vent valve has a membrane, e.g., a lipophobic membrane, and the membrane separates the ambient air from the oil of the transmission. An advantage is that air pressure is equalized by the membrane without oil escaping into the environment.

Further features and aspects of example embodiments of the present invention are explained in more detail below with reference to the appended schematic Figures.

### BRIEF DESCRIPTION OF THE DRAWINGS

FIG. 1 is a perspective view of a region of an electric motor, in which an oil reservoir 4 is fastened to a stator housing of the electric motor via a holding plate 2.

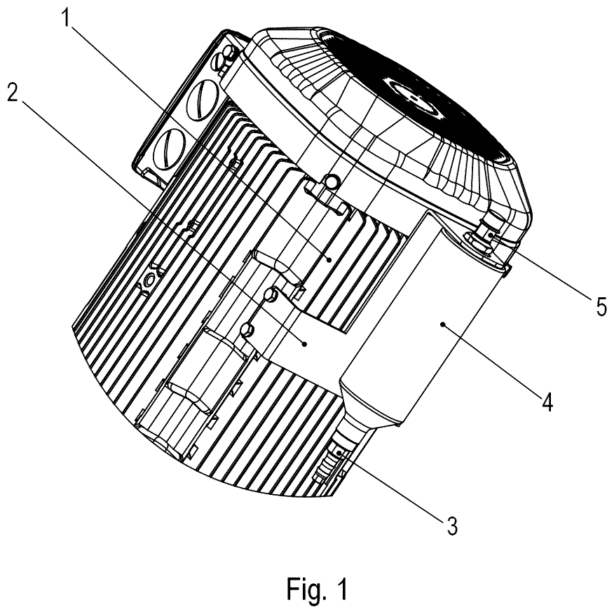

FIG. 2 is a perspective view of the holding plate 2.

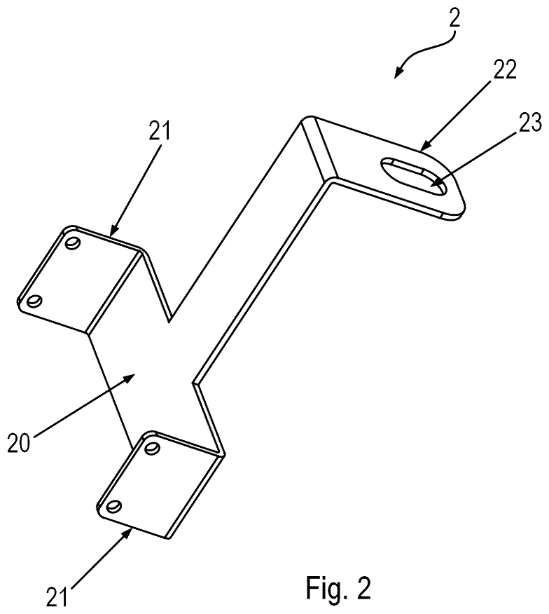

FIG. 3 is a perspective view of the oil reservoir.

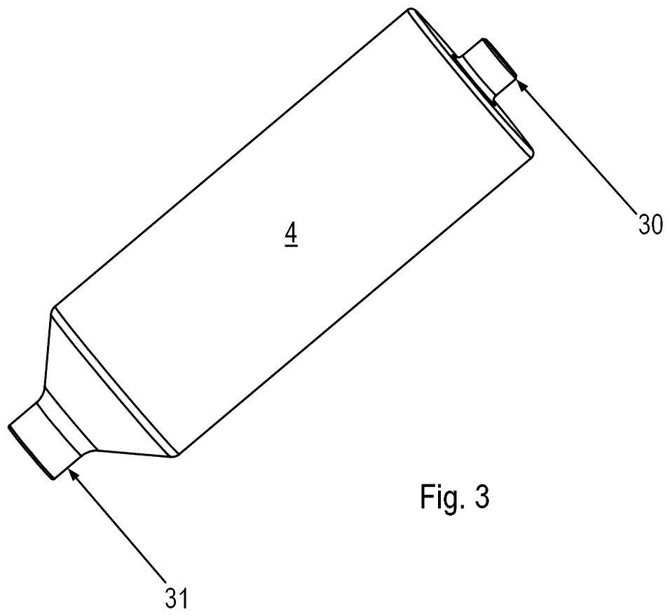

### DETAILED DESCRIPTION

As illustrated in the Figures, the stator housing has axially extending cooling fins 1 projecting radially from the stator housing.

The axial direction is oriented parallel to the axis of rotation of the rotor shaft of the electric motor; the radial direction and the circumferential direction are respectively related to the axis of rotation of the rotor shaft.

A first tab region 21 is fastened to a first of the cooling fins 1 of the stator housing via a screw, which projects through a recess of the first tab region 21 and through a recess of the first cooling fin 1. The screw head of the screw presses the first tab region 21 against the cooling fin 1.

A further first tab region 21 is fastened to a second of the cooling fins 1 of the stator housing via a further screw, which projects through a recess of the further first tab region 21 and through a recess of the further first cooling fin 1. The screw head of the screw presses the further first tab region 21 against the second cooling fin 1.

The two first tab regions 21 are spaced apart and adjoin a base region 20 of the holding plate 2 and are formed at an angle to the base region 20.

The base region 20 is, for example, flat, e.g., not curved.

A second tab region 22 is spaced apart from the two first tab regions 21 and also adjoins the base region 20 and is formed at an angle to the base region 20.

The holding plate 2 is manufactured as a punched and bent part from metal sheet, in which the holding plate 2, together with the base region 20, the two first tab regions 21 and the second tab region 22, is made in one piece, e.g., in one part.

The two first tab regions 21 are formed to be angled, e. g., bent, from the base region 20 towards the stator housing. The second tab region 22 is formed to be angled away, e.g., bent, from the stator housing.

In this manner, an oil reservoir 4 can be fastened to the holding plate 2. On the one hand, the oil reservoir has a connection region 31 for an adapter 3, to which an oil line, e.g., a pipeline or hose, can be connected. The oil line leads to a transmission driven by the electric motor.

On the side of the oil reservoir 4 opposite in the axial direction, the oil reservoir 4 has a connection region 30 for a vent valve 5.

The axial direction is, for example, parallel to the vertical direction.

The oil reservoir 4 is thus arranged above the transmission in the direction of gravity and acts as an oil expansion tank. When the transmission temperature rises, the oil in the transmission expands and the oil level in the oil reservoir 4 rises. There is air in the oil reservoir above the oil level. The air pressure is equalized by the vent valve 5, which, for example, has a semipermeable membrane and/or a lipophobic membrane. The membrane separates the inner spatial region of the oil reservoir 4 from the ambient air. Thus, oil or oil mist or similar media containing oil droplets are prevented from penetrating the membrane and thus also the vent valve 5.

The holding plate 2 is thus arranged between the oil reservoir 4 and the stator housing.

For example, the first cooling fin 1 is respectively freely accessible tangentially. This means that there are no further cooling fins that could make it difficult to access the respective screw.

For example, the cooling fin of the stator housing that is closest to the first cooling fin 1 in the circumferential direction is oriented perpendicular to the first cooling fin 1. For example, the circumferential direction points away from the second cooling fin 1, e.g., the one that rests against the further first tab region 21.

The cooling fin of the stator housing that is closest to the second cooling fin 1 in the opposite direction to the circumferential direction is oriented perpendicular to the second cooling fin 1. The circumferential direction points from the second cooling fin 1 to the first cooling fin 1.

Multiple cooling fins of the stator housing are arranged in the circumferential direction between the second cooling fin 1 and the first cooling fin 1. For example, these are oriented almost parallel or substantially almost parallel.

For example, the oil reservoir 4 together with the vent valve 5 does not project axially beyond the rest of the electric motor.

For fastening the oil reservoir 4 to the holding plate, the connection region 30 is passed through a recess of the second tab region 22 and has an externally threaded region onto which a nut is screwed, which rests against the second tab region 22, which is thus clamped between the nut and the rest of the oil reservoir 4.

The screws that press the holding plate onto the respective cooling fin are respectively oriented tangentially.

The second tab region 22 is arranged above the first tab region 21.

While the first and second cooling fins respectively have a continuous recess for the respective screws, the first tab regions 21 pressed down by the screw heads of the screws provide for efficient removal of heat loss. This is because the holding plate 2 is made of a sheet metal, e.g., sheet steel, and the stator housing with its cooling fins 1 is made of a metal, e.g., steel, cast steel, die-cast aluminum, or continuous cast aluminum.

On the side of the stator housing facing away from the transmission in the axial direction, a fan is connected for conjoint rotation with the rotor shaft of the electric motor. Thus, passive fan operation can be achieved.

The air flow conveyed by the fan flows out between the stator housing and a fan hood along the cooling fins 1, so that part of the air flow flows between the stator housing and the holding plate 2.

This not only improves heat dissipation of the electric motor, but also improves cooling of the oil reservoir 4. The oil cooled in this manner thus also contributes to the heat dissipation of the transmission. Additionally, the fan only drives an airflow that flows in the opposite direction to the direction of gravity, e.g., downwards, when the rotor shaft is rotating. However, when the rotor shaft is rotating, a high power dissipation is also effective in the transmission, which leads to an increase in the temperature of the oil of the transmission.

When the rotor shaft is idle and the oil is still hot, a convectively driven air flow moves upwards, i.e., in the opposite direction to the direction of gravity.

The direction of the cooling air flow is thus reversed when operation of the electric motor is terminated.

The two first tab regions 21 are oriented parallel to each other.

The second tab region 22 is oriented perpendicular to the two first tab regions 21.

For example, both the two first tab regions 21 and the second tab region 22 as well as the base region 20 are flat. The second tab region 22 is oriented perpendicular to the base region 20. The two first tab regions 21 are also oriented perpendicular to the base region 20.

According to example embodiments, further tab regions are partially punched out on the base region 20 and bent towards the stator housing, so that at least part of the cooling air flow is directed to the oil reservoir 4 via the further tab regions through the recesses in the base region 20 created when the further tab regions were punched out. In this manner, the heat dissipation of the oil reservoir 4 is improved.

### LIST OF REFERENCE NUMERALS

1 Cooling fins of the stator housing
2 Holding plate
3 Adapter
4 Oil reservoir
5 Vent valve
20 Base region
21 First tab region
22 Second tab region
23 Recess
30 Connection region for vent valve 5
31 Connection region for adapter 3

1-15. (canceled)

16. An electric motor, comprising:
a stator housing including cooling fins, the cooling fins including a first cooling fin and a second cooling fin spaced from the first cooling fin;
a holding plate fastened to the first cooling fin of the stator housing and to the second cooling fin of the stator housing, the holding plate including a first tab region connected to the first cooling fin and a second tab region connected to the second cooling fin; and
an oil reservoir is fastened to the holding plate.

17. The electric motor according to claim 16, wherein the first tab region is screw-connected to the first cooling fin, and the second tab region is screw-connected to the second cooling fin.

18. The electric motor according to claim 16, wherein the oil reservoir is fastened to a third tab region of the holding plate.

19. The electric motor according to claim 16, wherein the holding plate is arranged between the oil reservoir and the stator housing.

20. The electric motor according to claim 16, wherein the first tab region includes at least one continuous recess directed in a circumferential direction or directed tangentially, the first cooling fin includes at least one continuous recess directed in the circumferential direction or directed tangentially, and/or the second cooling fin includes at least one continuous recess directed in the circumferential direction or directed tangentially.

21. The electric motor according to claim 16, wherein a first screw projects through the first tab region and the first cooling fin, and a second screw projects through the further first tab region and the second cooling fin.

22. The electric motor according to claim 16, wherein the holding plate is arranged as a punched and bent metal sheet part.

23. The electric motor according to claim 22, wherein each tab region adjoins a flat base region of the holding part and is arranged at an angle to the base region.

24. The electric motor according to claim 16, wherein the second tab region of the holding part adjoins a flat base region of the holding part and is arranged at an angle to the base region.

25. The electric motor according to claim 24, wherein the second tab region is bent away from the stator housing starting from the base region.

26. The electric motor according to claim 24, wherein the first tab region and/or the second tab region is substantially flat.

27. The electric motor according to claim 26, wherein the first tab region and/or the second tab region is bent away from the base region and toward the stator housing.

28. The electric motor according to claim 16, wherein the oil reservoir includes a connection region for a vent valve and a connection region for an adapter.

29. The electric motor according to claim 16, wherein an axial direction of the electric motor is vertical.

30. The electric motor according to claim 28, wherein the connection region for the vent valve is arranged above the connection region for the adapter.

31. The electric motor according to claim 16, wherein a fan is connected for conjoint rotation to a rotor shaft of the electric motor, the fan configured to convey an air flow to exit between a fan hood of the electric motor and the stator housing and to flow at least partially along the holding plate and/or the oil reservoir.

32. The electric motor according to claim 31, wherein the fan is configure to convey the air flow to flow directed downwardly in the direction of gravity.

33. The electric motor according to claim 28, wherein the connection region for the vent valve projects through a recess of the second tab region.

34. The electric motor according to claim 33, wherein a nut is screwed onto the connection region tor fastening the oil reservoir to the second tab region.

35. The electric motor according to claim 28, wherein a rotor shaft of the electric motor is configured to drive a transmission having an inner spatial region filled with oil, and an oil line, a pipeline, and/or a hose line leads from the transmission to the adapter, which is connected to the connection region for the adapter.

36. The electric motor according to claim 28, wherein the vent valve is connected to the connection region for the vent valve.

37. The electric motor according to claim 36, wherein the vent valve includes a membrane and/or a lipophobic membrane that separates ambient air from oil of a transmission.
